(19) United States
(12) Patent Application Publication
(10) Pub. No.: US 2018/0054854 A1
(43) Pub. Date: Feb. 22, 2018

(54) WIRELESS COMMUNICATION DEVICE AND WIRELESS COMMUNICATION METHOD

(71) Applicant: ISOFT POWER TECHNOLOGY LTD., Beijing (CN)

(72) Inventor: Xin LIU, Beijing (CN)

(21) Appl. No.: 15/794,037

(22) Filed: Oct. 26, 2017

Related U.S. Application Data
(63) Continuation of application No. PCT/CN2015/091750, filed on Oct. 12, 2015.

(30) Foreign Application Priority Data
May 4, 2015 (CN) 201510220935.5

(51) Int. Cl. H04W 88/04; H04W 12/06; H04W 76/02

(52) U.S. Cl. CPC H04W 88/04; H04W 12/08; H04W 76/023; H04W 12/06

(57) ABSTRACT

Provided is a wireless communication device, comprising: a verifying module, configured to perform identity verification on user of the wireless communication device; a first accessing module, configured to establish, when the verifying module verifies the user successfully, a cloud service connection with cloud server end of the user via a wireless communication network; a second accessing module, configured to establish a short-range wireless connection with one or more external terminal device(s); and a transmitting module, configured to relay data between the external terminal device and the cloud server end via the short-range wireless connection and the cloud service connection. One wireless communication device provides a uniform access and verification processing of a cloud service for one user, so that lower design requirement is required from various terminal devices of the user, and costs of the terminal devices can be reduced.

### CROSS-REFERENCE TO RELATED APPLICATIONS

This application is a continuation of International Application No. PCT/CN2015/091750, filed on Oct. 12, 2015, which claims priority to Chinese Patent Application No. 201510220935.5, filed on May 4, 2015. The disclosures of the aforementioned applications are hereby incorporated by reference in their entireties.

### TECHNICAL FIELD

Embodiments of the present disclosure relate to the field of wireless communications, and more particularly, to a wireless communication device and a wireless communication method.

### BACKGROUND

Currently terminal devices such as a mobile terminal and a notebook computer are generally required to be integrated with multiple accessing modules inside, such as a WiFi module and a mobile communication network accessing module, in order to meet access requirements of different networks. As such, it would result in complexity of hardware design of a terminal device and increased device costs.

In addition, when a terminal device needs to use a cloud service, the terminal device needs to perform a verification processing on the cloud service via a browser or a cloud service client end, which results in complexity of software design of the terminal device, and even a need to design an operating system or an application software dedicated for the terminal device individually, and increased device costs as well.

### SUMMARY

Embodiments of the present disclosure provide a wireless communication device, which can reduce design and production costs of a terminal device.

On one aspect, provided is a wireless communication device, comprising: a verifying module, configured to perform an identity verification on a user of the wireless communication device; a first accessing module, configured to establish, when the verifying module verifies the user successfully, a cloud service connection with a cloud server end of the user via a wireless communication network; a second accessing module, configured to establish a short-range wireless connection with one or more external terminal device(s); and a transmitting module, configured to relay data between the external terminal device and the cloud server end via the short-range wireless connection and the cloud service connection.

Optionally, the verifying module is further configured to perform an access verification with the wireless communication network.

Optionally, the verifying module is further configured to perform a login verification with the cloud server end.

Optionally, the wireless communication network includes a mobile communication network and/or a wireless local area network.

Optionally, the wireless communication device is a portable device.

Optionally, the identity verification includes at least one of a biological information verification, an input verification and a hardware device verification.

Optionally, the short-range wireless connection includes at least one of a WiFi connection, a Bluetooth connection, an infrared connection and a visible light connection.

On the other aspect, provided is a wireless communication system, comprising a wireless communication device and a cloud server end mutually connected via a wireless communication network, where the cloud server end is configured to provide a cloud service to a user of the wireless communication device; the wireless communication device is configured to perform an identity verification on the user of the wireless communication device, and establish a cloud service connection with the cloud server end via the wireless communication network when the user is successfully verified; the wireless communication device is further configured to establish a short-range wireless connection with one or more external terminal device(s); and the wireless communication device is further configured to relay data of the cloud service between the external terminal device and the cloud server end via the short-range wireless connection and the cloud service connection.

On the other aspect, provided is a communication method of a wireless communication system, characterized in that the wireless communication system includes a wireless communication device and a cloud server end mutually connected via a wireless communication network, and the cloud server end provides a cloud service to a user of the wireless communication device, and the method includes: performing, by the wireless communication device, an identity verification on the user of the wireless communication device; establishing, by the wireless communication device, a cloud service connection with the cloud server end via the wireless communication network when the user is successfully verified; establishing, by the wireless communication device, a short-range wireless connection with one or more external terminal device(s); and relaying, by the wireless communication device, data of the cloud service between the external terminal device and the cloud server end via the short-range wireless connection and the cloud service connection.

In the embodiments of the present disclosure, one wireless communication device provides a uniform access and verification processing of a cloud service for one user, so that lower design requirement is required from various terminal devices of the user, and design and production costs of the terminal devices can be reduced.

### BRIEF DESCRIPTION OF DRAWINGS

A brief description will be made below to the drawings.

FIG. 1 is an example of an applicable network scenario of an embodiment of the present disclosure;

FIG. 2 is a schematic block diagram of a wireless communication device of an embodiment of the present disclosure;

FIG. 3 is a schematic interaction diagram of one applicable scenario example of the present disclosure;

FIG. 4 is a schematic interaction diagram of another applicable scenario example of the present disclosure;

FIG. 5 is a schematic interaction diagram of another applicable scenario example of the present disclosure;

FIG. 6 is a schematic block diagram of a cloud server end of an embodiment of the present disclosure; and

FIG. 7 is a flowchart of a communication method of a wireless communication system of an embodiment of the present disclosure.

### DESCRIPTION OF EMBODIMENTS

The technical solution in the embodiments of the present disclosure will be described clearly and fully below in conjunction with the drawings in the embodiments of the present disclosure.

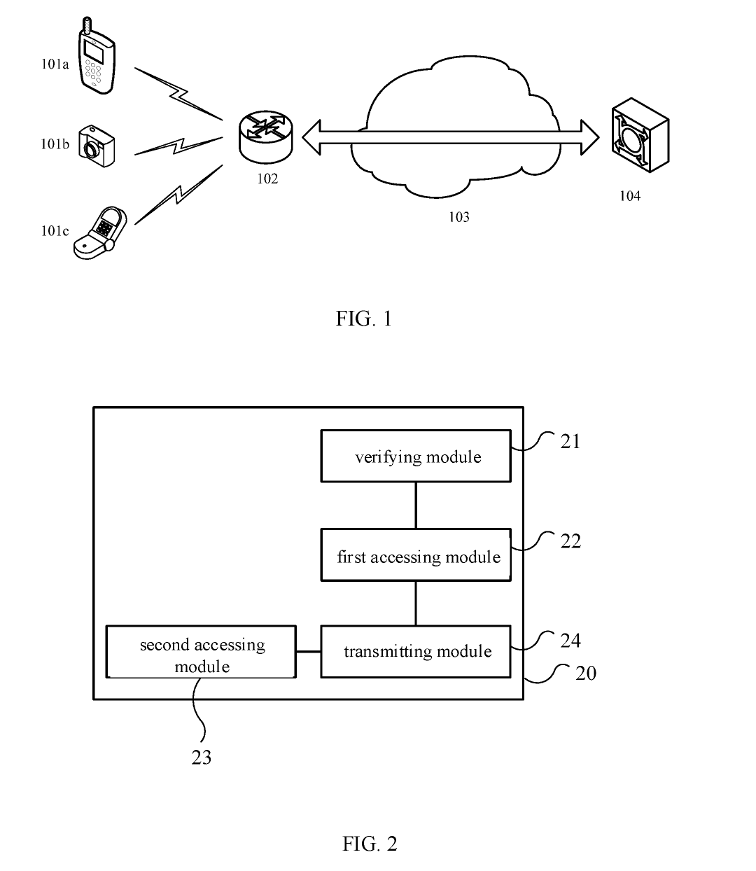

FIG. 1 is an example of an applicable network scenario of an embodiment of the present disclosure.

The network scenario of FIG. 1 may include at least one terminal device 101a, 101b, 101c, etc. (in the text below, if no distinction of these terminal devices is required, the terminal devices may be collectively referred to as terminal device 101). An example of FIG. 1 depicts a scenario of three terminal devices, however, the present disclosure does not make a limitation to the number of the applicable terminal device 101.

The present disclosure does not make a limitation to the type of the terminal device 101 either. For example, the terminal device 101 may be a mobile terminal, such as a cell phone, a tablet device, a wearable device, and the like; the terminal device 101 may also be a computer, such as a notebook computer and the like; and the terminal device 101 may also be an electronic device for other uses, such as a digital camera, a scanner, an electronic book, and the like.

A cloud server end 104 is configured to provide a cloud service to a user, such as cloud storage, cloud computing, cloud exchange, etc. The cloud service is generally provided for users so that the same user may use the same cloud service on different devices. For example, one user may use a digital camera to capture a picture, a cloud server end receives and stores the picture from the digital camera, and then the user may view the captured picture on other devices (such as a cell phone) via a cloud service, or may edit the captured picture on other devices (such as a computer) via the cloud service.

It should be noted that “a user” in the present disclosure not only includes a case of an individual user, but also that of the same user used by a number of people, for example, all members of one family may use a cloud service corresponding to the same user.

In a case where a number of people use the same user, these people may use the same user name/password, and may also use different user names/passwords. As one schematic example for using the same user name/password, with regard to a cloud sharing service for pictures for example, a number of people may all use a user name user 1, and a password pw1. As one schematic example for using different user names/passwords, with regard to a cloud service for a group chat of a user groupi (representing the i-th group chat) for example, each participant of the group chat may use his or her own user name groupi_userj (representing the j-th participant in the i-th group chat) and a corresponding password pwj. The format of the user name/password in the example given above is merely exemplary, and does not constitute a limitation to the scope of the present disclosure.

A wireless communication network 103 may include various available wireless communication protocol networks. For example, the wireless communication network 103 may include a mobile communication network, such as a GSM network, a CDMA network, a WCDMA network, an LTE network, an LTE-A network or other mobile communication networks. In the mobile communication network, an access and routing function is generally provided to a wireless communication device 102 via a base station (such as a BS, a NodeB, an eNodeB, etc.).

For another example, the wireless communication network 103 may include a wireless local area network (WLAN), such as a network in support of a WiFi protocol or other types of wireless local area networks. In the wireless local area network, an access and routing function is generally provided to the wireless communication device 102 via an access point (such as an AP, etc.).

Furthermore, the wireless communication network 103 may further include other types of communication devices required for providing a cloud service, for example, may include communication devices via a wired connection, such as a core network, a wide area network, and other parts. As another embodiment, the wireless communication network 103 may further support a hybrid network comprising a mobile communication network and a wireless local area network, for example, the wireless communication device 102 may access the mobile communication network and the wireless local area network simultaneously, where the two networks provide an offloading function with each other to improve system throughput. A control plane of the wireless communication device 102 may be disposed on one of the two networks, or the wireless communication device 102 may be coordinately controlled by the two networks.

The network scenario of FIG. 1 may further include the wireless communication device 102 according to an embodiment of the present disclosure. The wireless communication device 102 is mainly used for supporting a uniform access and verification of each of the terminal devices 101 for one user. Therefore, the wireless communication device 102 may be referred to as “a cloud hotspot” or “a cloud hotspot device”. Such a cloud hotspot is responsible for completing all control plane functions (such as an access and verification, etc.) related to a cloud service between a user and a cloud end. After completing a verification (a cloud service verification) with the cloud server end, the cloud hotspot may maintain a connection with the cloud server end to the greatest extent (e.g., through a heartbeat mechanism, a standby mechanism, a keep-alive mechanism or other similar mechanisms), so as to provide a cloud service for a newly connected terminal at any time. Such a cloud hotspot may be regarded as an extension channel entrance for the cloud server end to follow user's movement. Of course, after completing the cloud service verification, the cloud hotspot may also keep silent and be activated as required, and may maintain a context of the cloud hotspot at the cloud server end all the time (or during a significant period of time) so that the cloud hotspot may recover a channel function as soon as possible when there is a need to provide a cloud service to a terminal of a user. Generally speaking, user plane data related to a cloud service between a terminal of the user and a cloud end may also be relayed and transferred via a cloud hotspot.

Specifically, one user may own one or more terminal devices 101. When these terminal devices 101 are using the cloud service, the wireless communication device 102 is responsible for access and verification tasks of both the wireless communication network 103 and the cloud server end 104, while the terminal devices 101 only need a short-range wireless connection capability to be easily connected with the wireless communication device 102. Optionally, in order to enable the terminal devices 101 of the user to use the cloud service more conveniently and quickly, the cloud hotspot may not perform a connection verification on the terminal devices 101, for example, when the cloud hotspot uses a Bluetooth function, the Bluetooth function may be set to be in open connection with any neighboring terminal device without input of a matching character string by the terminal device. Of course, for the sake of security, the cloud hotspot may also perform the connection verification on the terminal devices 101. Alternatively, the connection verification may be set not to be performed merely on a secure terminal device 101 (e.g., the terminal device 101 has been previously connected), but to be performed on other terminal devices 101.

According to the embodiment of the present disclosure, the terminal devices 101 may not need a complex hardware and software design for a communication network and a cloud service, but only a short-range wireless connection with the wireless communication device 102. For example, the terminal devices 101 may only support a WiFi connection function, and the wireless communication device 102 completes a cloud service verification and a wireless communication network verification of a user, so that the terminal devices 101 may use a cloud service for the user provided by the cloud server end 104 directly after establishing a WiFi connection with the wireless communication device 102 of a certain user.

It should be noted that in the embodiment of the present disclosure, “a short-range wireless connection” refers to a short-range communication mode in the order of a hundred meters or shorter in distance, for example, a range covering several meters or tens of meters, or even a range as short as several centimeters or a near field, rather than a connection mode of a mobile communication network in the order of several hundreds of meters and even several kilometers. Typical examples of the short-range wireless connection are WiFi, Bluetooth, infrared, and visible light connection (such as an indoor light), near-field electromagnetic induction, etc., but exclude a wireless communication system utilizing a base station, such as 2G, 3G, 4G or 5G, etc. Specifically, two sides in a short-range wireless connection establish a connection without a third party device such as a base station (neither a control plane nor a data plane needs intervention of a base station), but connect therebetween directly based on a corresponding communication protocol.

In the embodiment of the present disclosure, the wireless communication device 102 performs an identity verification on a user, for example, adopting a biological information verification (such as a fingerprint, an iris, voice, facial identification, vascular patterns, etc., or any combination of these modes), an input verification (e.g., a user may input a user name/password thereof through an input device such as a button, a keyboard, a mouse, a microphone, etc.), a hardware device verification (such as a subscriber card, an NFC card, a key, etc.), or any combination of each of the above verification modes.

Access and verification processing for a certain user to access a wireless communication network (e.g., through verification such as a SIM, a UIM, a MAC address, an IP address, etc.) or login verification processing for logging in a cloud server end (e.g. inputting a user name/password of a cloud service, etc.) may be performed separately before or after the wireless communication device 102 performs an identity verification of the user. Alternatively, according to setting of the network/the cloud server end, the above access verification or the login verification is performed by incorporating the identity verification of the user, for example, the wireless communication device 102 may be customized for a certain cloud service, and a correspondence among the wireless communication device 102, a corresponding cloud service and corresponding user identity information is established in the cloud server end 104; and when the wireless communication device 102 verifies the user identity successfully, the wireless communication device 102 logs in the cloud service directly without cloud service login verification. The incorporated verification mode may be similarly applied to access verification of the wireless communication network 103.

As such, in the embodiment of the present disclosure, a hardware/software design requirement for the terminal devices 101 is lower, and the terminal devices 101 only need a short-range wireless connection capability to be easily connected with the wireless communication device 102, so that costs of a production provider of the terminal devices 101 may be reduced significantly, for example, addition of a WiFi module or a Bluetooth module simply on the basis of an existing electronic device without communication capability is merely needed. Meanwhile, the technical solution of the present disclosure does not give away use security simultaneously with providing use convenience, and an identity verification needs to be performed on a user when a cloud hotspot is used, in other words, the cloud hotspot is customized for the user, even though the cloud hotspot is lost or stolen, other users cannot pass the identity verification either, and therefore, cannot use the cloud hotspot to obtain a cloud service and relevant data of the cloud service. Further, the cloud hotspot of the present disclosure may provide a security processing capability such as positioning, locking and the like, for example, when the number of failure times of user verification reaches a predetermined number of times, the cloud hotspot can be locked to be incapable of further use; alternatively or additionally, the cloud hotspot may send its location to the cloud server end or other network side devices so that an actual user of the cloud hotspot retrieves the cloud hotspot in time.

In the embodiment of the present disclosure, since access to the terminal device 101 no longer needs a complex login verification process, user experience is better and convenience is higher.

In addition, a cloud hotspot of the embodiment of the present disclosure is bound with a corresponding cloud service, an identity verification performed by the cloud hotspot is also an identity verification required by the corresponding cloud service, whereas a traditional hotspot device (such as a WiFi hotspot) merely provides a communication channel, but is unrelated with a cloud service. The traditional WiFi hotspot merely performs user verification on a user for security of a network operator regardless of requirements of the cloud service, and therefore, cannot be bound with the cloud service and the user, and cannot provide a user personalized service based on the cloud service.

Moreover, an operation for use of a cloud service via a traditional WiFi hotspot is relatively complex, a specific app, a client end proxy or a browser are generally required to be mounted on a terminal so as to be connected with a cloud server end through such app, client end proxy or browser, and this requires software support of the terminal, for example, software support of an application layer and even an operating system layer, especially for some conventional terminals, such as a television, a camera and the like; and such software needs to be specifically developed, costs are higher and use is inconvenient, subsequent software update is also troublesome, and not beneficial to continuous upgrading and reconstruction of an entire cloud service. However, a cloud hotspot of the embodiment of the present disclosure does not require complex software support of a terminal. When a cloud service is upgraded, the cloud hotspot of the present disclosure only requires to upgrade software of the cloud hotspot without upgrading software of each terminal like a traditional WiFi hotspot solution. A function of a future cloud service necessarily requires to upgrade and promote performance continuously so as to bring more values to a user. A cloud hotspot of the present disclosure is more suitable to this application environment.

FIG. 2 is a schematic block diagram of a wireless communication device of an embodiment of the present disclosure. A wireless communication device 20 of FIG. 2 is a specific example of the wireless communication device 102 of FIG. 1.

As shown in FIG. 2, the wireless communication device 20 includes a verifying module 21, a first accessing module 22, a second accessing module 23 and a transmitting module 24.

The verifying module 21 is configured to perform an identity verification on a user of the wireless communication device 20. For example, the verifying module 21 may adopt a biological information verification (such as a fingerprint, an iris, voice, facial identification, vascular patterns, etc., or any combination of these modes), an input verification (e.g. a user may input a user name/password of the user through an input device such as a button, a keyboard, a mouse, a microphone, etc.) and a hardware device verification (such as a subscriber card, an NFC card, a key, etc.), or any combination of each of the above verification modes.

The first accessing module 22 is configured to establish, when the verifying module 21 verifies the user successfully, a cloud service connection with a cloud server end (e.g., the cloud server end 104 shown in FIG. 1) of the user via a wireless communication network (such as the wireless communication network 103 shown in FIG. 1).

The second accessing module 23 is configured to establish a short-range wireless connection with one or more external terminal device(s) (e.g., the terminal devices 101 shown in FIG. 1). Examples of the short-range wireless connection may include a WIFI connection, a Bluetooth connection, an infrared connection, a visible light connection, etc. The visible light connection may adopt, for example, a spectrum of a lamplight to connect, and perform communication using fast on-off of a visible light (generally, at a speed imperceptible to human eyes).

The transmitting module 24 is configured to relay data between the external terminal device and the cloud server end via the short-range wireless connection and the cloud service connection.

As such, in the embodiment of the present disclosure, one wireless communication device provides a uniform access and verification processing of a cloud service for one user, so that lower design requirement is required from various terminal devices of the user, and design and production costs of the terminal devices can be reduced.

Furthermore, the uniform access and verification processing of a cloud service for one user provided by one wireless communication device, interconnection between each of terminal devices of the user can be realized better, for example, a picture captured by a digital camera of the user may perform instant presentation on a cell phone of the user conveniently, thereby enhancing user experience significantly.

Optionally, as another embodiment, the verifying module 21 may further perform an access verification with the wireless communication network (e.g., the wireless communication network 103 shown in FIG. 1). For example, the wireless communication device 20 may be provided with a slot for inserting a SIM card or a similar subscriber identity card, or the wireless communication device 20 may be internally installed with a SIM card (i.e., an embedded SIM card) or a similar subscriber identity card, and such a subscriber identity card is configured to perform access verification when the wireless communication network is accessed.

As another embodiment, an access verification processing of a wireless communication network may also be implemented by a cloud server end entirely (in this case, the cloud server end may be regarded as an access verification proxy of a wireless communication device) so as to exempt use of a subscriber identity card such as a SIM card, and save space of the wireless communication device 20 so that the volume of the wireless communication device 20 is more compact. In the other aspect, since messaging for an access verification processing between the wireless communication device 20 and the wireless communication network is not required, electric power of the wireless communication device 20 can also be saved. This is an actual NO-SIM-CARD solution. Currently, there exists solutions such as a virtual SIM card or an e-SIM card, however, these solutions do not exempt a SIM card completely, but merely convert the SIM card into a built-in or embedded chip.

Specifically, as one example, a correspondence between a device identifier (such as an IMEI or a similar identifier) and a predetermined user identifier (such as an IMSI or a similar identifier) of the wireless communication device 20 is bound at a cloud server end or an operator end in advance; access verification may be performed on the cloud server end after an identity verification is performed on the user (e.g., during establishment of the above cloud service connection) or independent of the identity verification (e.g., during initial activation of the wireless communication device 20); in other words, the present disclosure does not make a limitation to the time for such access verification. For example, in a case where an operator end stores correspondences between device identifiers and user identifiers, a cloud server end may send the device identifier of the wireless communication device 20 to a server of the operator end, and the operator end looks up the corresponding user identifier according to the device identifier of the wireless communication device 20, and performs an authentication and activation operation on the basis of the user identifier (e.g., exchanging authentication information with the cloud server end, and optionally, allocating a TMSI for the user identifier, and other operations), so that the wireless communication device 20 may perform communication with a wide area network using a wireless communication network. For another example, in a case where a cloud server end stores correspondences between device identifiers and user identifiers, the cloud server end may send the device identifier and the corresponding user identifier of the wireless communication device 20 to a server of an operator end, and the operator end performs an authentication and activation operation on the basis of the user identifier (e.g., exchanging authentication information with the cloud server end, and optionally, allocating a TMSI for the user identifier, and other operations), so that the wireless communication device 20 may perform communication with a wide area network using a wireless communication network.

As another example, a cloud server end may generate a user identifier according to a device identifier, for example, conversion between a device identifier and a user identifier may follow a specific algorithm, and the cloud server end converts the device identifier according to such algorithm to obtain a corresponding user identifier.

As yet another example, an operator end may allocate a user identifier for the wireless communication device 20 as required. Specifically, for example, a cloud server end may send a device identifier of the wireless communication device 20 to a server of the operator end, the operator end allocates a corresponding user identifier for the device identifier of the wireless communication device 20, and performs an authentication and activation operation on the basis of the user identifier (e.g., exchanging authentication information with the cloud server end, and optionally, allocating a TMSI for the user identifier, and other operations), so that the wireless communication device 20 may perform communication with a wide area network using a wireless communication network.

As another simpler solution, a device identifier and a user identifier of a wireless communication device may be united to be one identifier. For example, a user identifier IMSI may be directly used as a device identifier of a wireless communication device, and vice versa.

In the above NO SIM CARD solution, for security of authentication, authentication information corresponding to a user identifier (such as an IMSI) is stored in both a cloud server end and an operator end (such as an authentication server), for example, a Ki secret key, an algorithm version, and the like for use in the authentication process; in addition, information interaction between the cloud server end and the operator end may be encrypted so as to further enhance security of authentication. The specific authentication algorithm may refer to an existing algorithm.

After the operator end allocates a TMSI, the operator end may send the allocated TMSI to the cloud server end; and for subsequent cloud service data messaging, the cloud server end may send the TMSI to the wireless communication device 20. Alternatively, the operator end may send the allocated TMSI to the cloud server end directly.

Optionally, as another embodiment, the verifying module 21 may further perform a login verification with a cloud server end. For example, the wireless communication device 20 may be provided with an input device or externally connected with an input device for inputting login verification information of the cloud server end, for example, a user name/password. As yet another embodiment, login verification of the cloud server end may be incorporated with the above identity verification, for example, a user fingerprint may be acquired, and the fingerprint information may be used for the identity verification and the login verification of the cloud server end simultaneously; at this time, correspondences between users and fingerprint information thereof may be recorded at the cloud server end.

Optionally, as still another embodiment, a wireless communication network (e.g., the wireless communication network 103 shown in FIG. 1) may include a mobile communication network and/or a wireless local area network. For example, the wireless communication network may be a cellular network provided by a wireless operator, including an access network element, a core network element and other devices, and connected with a server of a cloud server end or the server of the cloud server end via a wide area network. The wireless local area network may be a WiFi network that is connected with a wide area network through devices such as a router and a switch, and further to a server of a cloud server end.

Furthermore, in the embodiment of the present disclosure, a server of a cloud server end (e.g., the cloud server end 104 shown in FIG. 1) may be centralized or may also be distributed, and the present disclosure does not make a limitation to it.

Optionally, as one embodiment, the verifying module 21 may lock the wireless communication device to be incapable of further use, and/or send a location of the wireless communication device to the cloud server end or other network side devices through the transmitting module 24, when the number of failure times of the identity verification reaches a predetermined number of times. This can enhance security of a cloud service for a user, prevent leakage of user information after a cloud hotspot is lost or stolen, and may help the user retrieve the cloud hotspot according to location information, and reduce user loss.

A cloud service may provide various types of services, such as a picture stream, a video stream or a character stream and the like. For different data streams, there may be characteristic processing instructions respectively in order to provide diversified services for a user.

Some embodiments of the present disclosure are described in details below in conjunction with specific examples. It should be noted that examples below are just for helping those skilled in the art to better understand concepts of the present disclosure, instead of limiting the scope of the present disclosure.

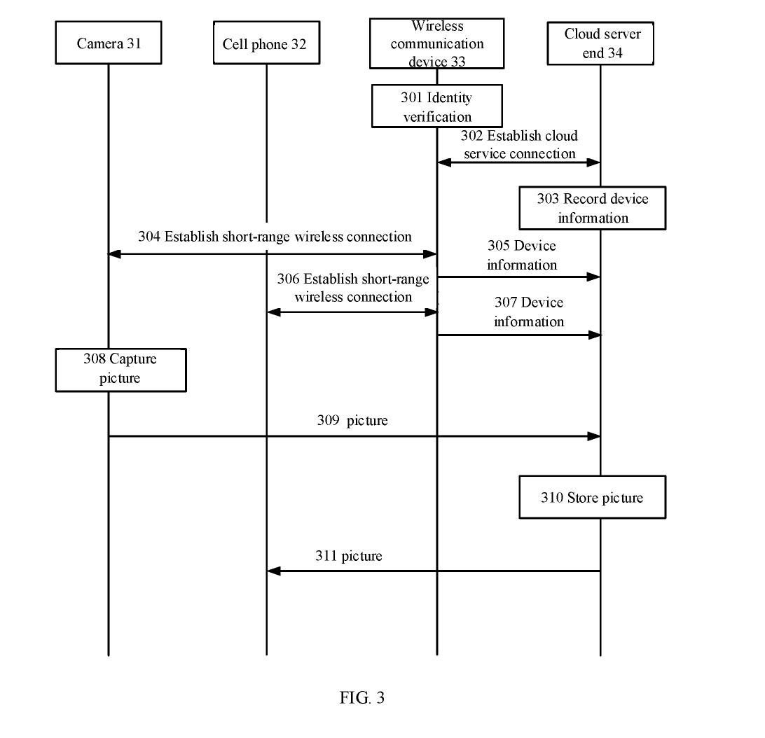

FIG. 3 is a schematic interaction diagram of one applicable scenario example of the present disclosure. FIG. 3 is an exemplary scenario in which a cloud service provides a picture stream. In an embodiment of FIG. 3, a user carries a portable wireless communication device 33, and a camera 31 and a cell phone 32 of the user establish short-range wireless connections with the wireless communication device 33 respectively so that a cloud service of the user can be used. The wireless communication device 33 may be the wireless communication device 102 of FIG. 1 or the wireless communication device 20 of FIG. 2. In addition, the user has achieved purchase of a cloud service of a cloud server end 34, and user information of the user is recorded at the cloud server end 34, for example, a user name, permission, etc. In the embodiment of FIG. 3, a cloud sharing service is used as a non-limiting specific example for a cloud service.

301, the wireless communication device 33 performs an identity verification on a user, such as a biological information verification, an input verification and a hardware device verification, etc.

302, when the identity verification is successful, the wireless communication device 33 establishes a cloud service connection with the cloud server end 34 of the user via a wireless communication network. Optionally, the cloud server end 34 may perform a login verification with a user once again during establishment of a cloud service connection.

Optionally, when identity verification fails or the number of failure times of the identity verification reaches a predetermined number of times (e.g., three times, five times, etc.), the wireless communication device 33 may be locked to be incapable of further use, for example, it may be locked for a period of time before the identity verification is performed once again; and when the identity verification performed once again fails or the number of failure times reaches a predetermined number of times again, it may be locked for longer time before the following identity verification is performed. In addition, optionally, when the accumulated number of times of identity verification during a predetermined time period (e.g., within a day or a week) reaches a greater numerical value (e.g., 10 times or 20 times), it is deemed that there is a great possibility that the wireless communication device 33 has been lost or stolen, and the wireless communication device 33 may send its current location to a predetermined device (e.g., the cloud server end 34 or other network side devices, such as a network side device providing security), so that a user of the wireless communication device 33 can acquire the current location of the wireless communication device 33 so as to facilitate retrieval of the wireless communication device 33. Sending of the current location may be periodic, and may also be triggered based on an event, for example, at the time when the accumulated number of times of identity verification reaches a greater numerical value, or the wireless communication device 33 receives a device retrieval command issued by a user through other means (e.g., issuing the device retrieval command through the cloud server end 34), the wireless communication device 33 is triggered to send the current location. This can enhance security of a cloud service.

303, the cloud server end 34 may record information of the wireless communication device 33, indicating that the wireless communication device 33 is being used by the user, so that a cloud sharing service provided by the cloud server end 34 can be used.

In this case, if a wireless communication device is temporarily disconnected from a wireless communication network or a cloud server end due to certain reasons (e.g., a signal quality is bad or a user logs out actively), the cloud server end may temporarily retain information about the wireless communication device recorded in step 303 within a certain time limit (such as within half an hour or ten minutes), so that the temporarily retained information can be used when the wireless communication device attempts to establish a connection with the cloud server end once again, thereby speeding up the process of attempting to establish a cloud service connection once again. Of course, the cloud server end may also release the recorded information about the wireless communication device when discovering the wireless communication device is disconnected so as to save storage space.

304, the camera 31 of the user establishes a short-range wireless connection with the wireless communication device 33. For example, the camera 31 may have a Bluetooth function module for establishing a Bluetooth connection with the wireless communication device 33. The present disclosure does not make a limitation to a protocol type and mode in which the camera 31 establishes the short-range wireless connection with the wireless communication device 33.

305, the wireless communication device 33 sends device information of the camera 31 to the cloud server end 34, and the cloud server end 34 records the device information of the camera 31. The device information may include but is not limited to a device identifier, device capability information (such as capturing a picture) and/or other parameter information (such as a format, a size of the picture, etc.) of the camera 31.

306, the cell phone 32 of the user establishes a short-range wireless connection with the wireless communication device 33. For example, the cell phone 32 may have a Bluetooth function module for establishing a Bluetooth connection with the wireless communication device 33. The present disclosure does not make a limitation to a protocol type and mode in which the cell phone 32 establishes the short-range wireless connection with the wireless communication device 33.

307, the wireless communication device 33 sends device information of the cell phone 32 to the cloud server end 34, and the cloud server end 34 records the device information of the cell phone 32. The device information may include but is not limited to a device identifier, device capability information (such as displaying a picture) and/or other parameter information (such as a format, a size of the picture, etc.) of the cell phone 32.

308, the user uses the camera 31 to capture a picture.

309, the camera 31 sends the captured picture to the cloud server end 34 through the wireless communication device 33. The process may be referred to as a picture synchronization processing. The camera 31 may perform picture synchronization simultaneously with capturing the picture, and may also perform picture synchronization according to an operation of the user (e.g., the user may input an instruction to indicate the camera 31 to perform a picture synchronization processing).

Optionally, the camera 31 may mark up the picture indicating which of pictures have been uploaded to the cloud server end, while which of pictures have not been uploaded.

310, the cloud server end 34 stores the picture uploaded by the camera 31. In addition, the cloud server end 34 may record relevant information of the picture, for example, source (i.e., the camera 31), capturing time, capturing place, etc.

311, the cloud server end 34 pushes the picture to the cell phone 32 through the wireless communication device 33.

For example, the cloud server end 34 discovers that the cell phone 32 also subscribes a cloud sharing service according to the device information of the cell phone 32, and therefore, sends the picture captured by the camera 31 to the cell phone 32. If the cell phone 32 has a specific requirement for a format or size of a picture, the cloud server end 34 may perform a format conversion processing on the picture uploaded by the camera 31 according to the specific requirement so as to satisfy the requirement of the cell phone 32. As one optional embodiment, especially in a case where a terminal device uploading data (i.e., a synchronization source of data) and a target terminal device to push the data (i.e., a synchronization destination of the data) do not use the wireless communication device 33 simultaneously, the format conversion processing is preferentially performed by the cloud server end 34.

As another embodiment, format conversion processing of a picture may also be performed by the wireless communication device 33, and even the cell phone 32. For example, when the wireless communication device 33 performs the above format conversion processing, the device information of the cell phone 32 may also be recorded on the wireless communication device 33 in advance. When sending the picture to the wireless communication device 33 via the cloud service connection, the cloud server end 34 may designate the destination of the picture as the cell phone 32; when receiving the picture, the wireless communication device 33 may perform a format conversion processing on the picture according to a format or size requirement locally stored in the device information of the cell phone 32 so as to satisfy the requirement of the cell phone 32, and send a converted picture to the cell phone 32 via a short-range wireless connection. In an optional embodiment, in a case where a synchronization source and a synchronization destination of data use the wireless communication device 33 simultaneously, the format conversion processing is preferentially performed by the wireless communication device 33.

In addition, the cloud server end 34 may perform a mark-up processing on a picture stored on the cloud server end 34 indicating whether the picture has been pushed to the cell phone 32.

As such, according to the present embodiment, use of a cloud service by a user terminal device can be achieved through a wireless communication device, and the user terminal device only needs a short-range wireless connection capability to be easily connected with the wireless communication device.

In the embodiment of FIG. 3, the terminal devices 31 and 32 of a user are not transparent to the cloud server end 34, that is, the cloud server end 34 may record identification information, connection state and the like of the terminal devices 31 and 32 of the user. However, the present disclosure is not limited to this, a cloud server end may not record or know the condition of a terminal device of a user either, and all operations of the cloud server end aim at a wireless communication device.

It should be noted that sequence numbers of steps in FIG. 3 do not constitute a limitation to execution sequence of the each step. For example, steps 306-307 are not necessarily executed ahead of steps 308-310. A similar scenario may be that a camera captures a picture, and then uploads the picture to a cloud server end for storage through a cloud hotspot; and a cell phone may be connected with the cloud server end through the cloud hotspot only after capturing, in this case, after a specific period of time, or when the cloud server end discovers that a new picture has not been pushed to the cell phone, the cloud server end may push the picture to the cell phone through the cloud hotspot.

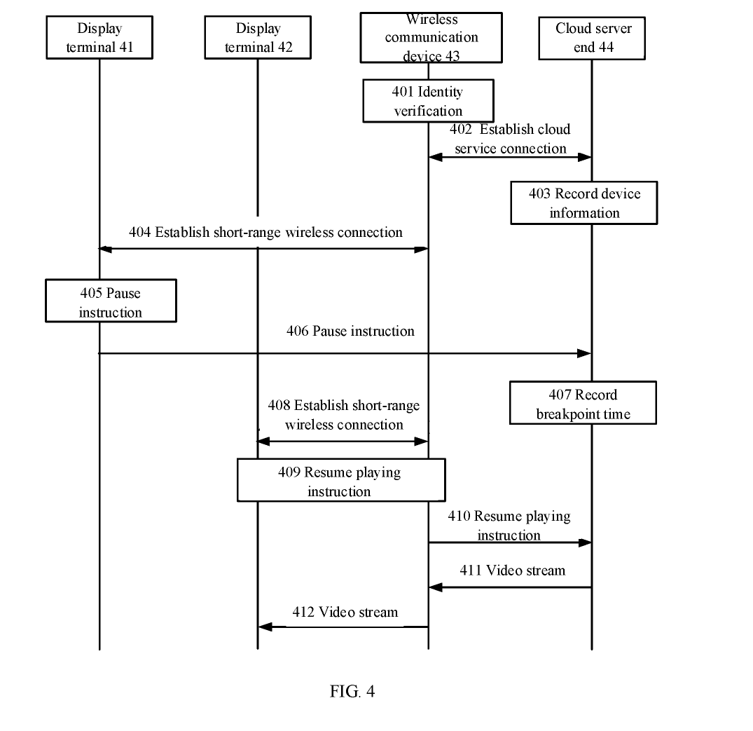

FIG. 4 is a schematic interaction diagram of another applicable scenario example of the present disclosure. FIG. 4 is an exemplary scenario in which a cloud service provides a video stream. In an embodiment of FIG. 4, a user carries a portable wireless communication device 43, and a display terminal 41 and a display terminal 42 of the user may be located at different places, and may establish short-range wireless connections with the wireless communication device 43, respectively.

In the embodiment of FIG. 4, a cloud video playing service is used as a non-limiting specific example for a cloud service.

401, the wireless communication device 43 performs an identity verification on a user, for example, a biological information verification, an input verification and a hardware device verification, etc.

402, when the identity verification is successful, the wireless communication device 43 establishes a cloud service connection with the cloud server end 44 of the user via a wireless communication network. Optionally, the cloud server end 44 may perform a login verification with a user once again during establishment of a cloud service connection.

Optionally, when identity verification fails or the number of failure times of the identity verification reaches a predetermined number of times (e.g., three times, five times, etc.), the wireless communication device 43 may be locked to be incapable of further use, for example, it may be locked for a period of time before the identity verification is performed once again; and when the identity verification performed once again fails or the number of failure times reaches a predetermined number of times again, it may be locked for longer time before the following identity verification is performed. In addition, optionally, when the accumulated number of times of identity verification during a predetermined time period (e.g., within a day or a week) reaches a greater numerical value (e.g., 10 times or 20 times), it is deemed that there is a great possibility that the wireless communication device 43 has been lost or stolen, and the wireless communication device 43 may send its current location to a predetermined device (e.g., the cloud server end 44 or other network side devices, such as a network side device providing security), so that a user of the wireless communication device 43 can acquire the current location of the wireless communication device 43 so as to facilitate retrieval of the wireless communication device 43. Sending of the current location may be periodic, and may also be triggered based on an event, for example, at the time when the accumulated number of times of identity verification reaches a greater numerical value, or the wireless communication device 43 receives a device retrieval command issued by a user through other means (e.g., issuing the device retrieval command through the cloud server end 44), the wireless communication device 43 is triggered to send the current location. This can enhance security of a cloud service.

403, the cloud server end 44 may record information of the wireless communication device 43, indicating that the wireless communication device 43 is being used by the user, so that a cloud video playing service provided by the cloud server end 44 can be used.

404, the display terminal 41 of the user establishes a short-range wireless connection with the wireless communication device 43. For example, the display terminal 41 may have a Bluetooth function module for establishing a Bluetooth connection with the wireless communication device 43. The present disclosure does not make a limitation to a protocol type and mode in which the display terminal 41 establishes the short-range wireless connection with the wireless communication device 43.

As one non-limiting example, the display terminal 41 may be a tablet computer in the home of a user, and the user uses the tablet computer to use a cloud video playing service provided by the cloud server end 44 through the wireless communication device 43, for example, watching a certain movie.

405, the user needs to go out to home of a friend, and therefore, inputs a pause instruction on the display terminal 41 (the tablet computer) to suspend the playing of the movie.

406, the display terminal 41 sends the pause instruction of the user to the cloud server end 44 through the wireless communication device 43. Optionally, the display terminal 41 or the wireless communication device 43 may send breakpoint time information at the pause point together to the cloud server end.

407, the cloud server end 44 suspends pushing of a video stream of the movie, and records the breakpoint time information of the movie at this time after receiving the pause instruction of the user.

The breakpoint time information herein may be sent and indicated from the wireless communication device 43, and determined by the cloud server end 44 on its own as well.

408, the user arrives at the friend's home, and the display terminal 42 of the friend establishes a short-range wireless connection with the wireless communication device 43. For example, the display terminal 42 may have a Bluetooth function module for establishing a Bluetooth connection with the wireless communication device 43. The present disclosure does not make a limitation to a protocol type and mode in which the display terminal 42 establishes the short-range wireless connection with the wireless communication device 43.

As one non-limiting example, the display terminal 42 may be a television in the friend's home, and the user uses the television to use a cloud video playing service provided by the cloud server end 44 through the wireless communication device 43, for example, watching a certain movie.

409, the user inputs an instruction to resume playing the movie paused at step 405 on the wireless communication device 43 or the display terminal 42.

The wireless communication device 43 may provide an instruction menu for a user to input a resume playing instruction, or the wireless communication device 43 may send instruction menu information to the display terminal 42 so that the display terminal 42 displays the instruction menu according to the instruction menu information, thereby allowing the user to input the instruction to resume playing on the display terminal 42.

410, the wireless communication device 43 sends the resume playing instruction to the cloud server end 44. Optionally, if the user watches multiple movies simultaneously, information about a movie that the user wishes to resume playing (such as movie number, movie title, etc.) may further be sent to the cloud server end 44.

411, after receiving the resume playing instruction, the cloud server end 44 continues to push the video stream of the movie to the wireless communication device 43 at a breakpoint time indicated by the breakpoint time information recorded at step 407.

412, the wireless communication device 43 relays the video stream of the movie to the display terminal 42 so that the user can resume watching the movie on the display terminal 42.

As such, according to the present embodiment, use of a cloud service by a user terminal device can be achieved through a wireless communication device, and the user terminal device only needs a short-range wireless connection capability to be easily connected with the wireless communication device.

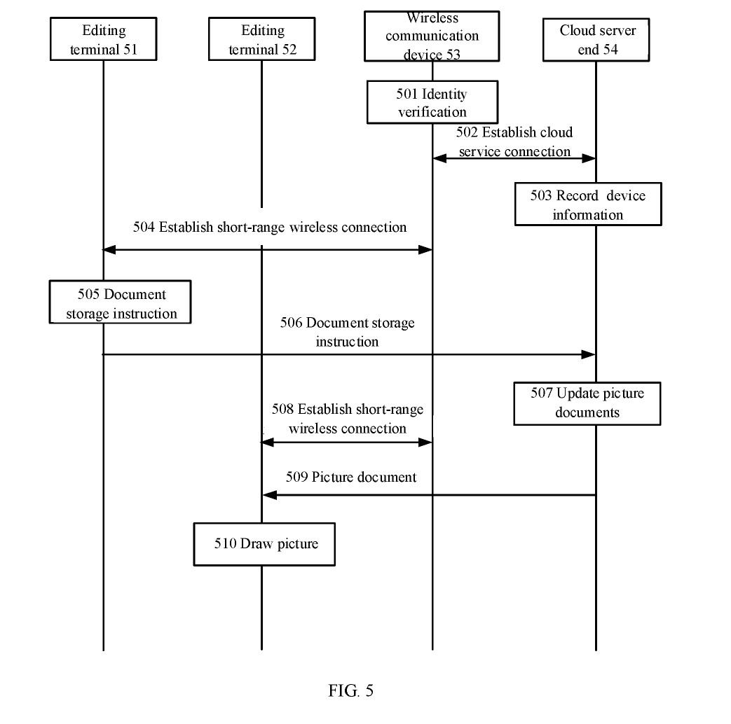

FIG. 5 is a schematic interaction diagram of another applicable scenario example of the present disclosure. FIG. 5 is an exemplary scenario in which a cloud service provides a character stream. In an embodiment of FIG. 5, a user carries a portable wireless communication device 53, and an editing terminal 51 and an editing terminal 52 of the user may be located at different places, and may establish short-range wireless connections with the wireless communication device 53, respectively.

In the embodiment of FIG. 5, a cloud editing service is used as a non-limiting specific example for a cloud service.

501, the wireless communication device 53 performs an identity verification on a user, for example, a biological information verification, an input verification and a hardware device verification, etc.

502, when the identity verification is successful, the wireless communication device 53 establishes a cloud service connection with a cloud server end 54 of the user via a wireless communication network. Optionally, the cloud server end 54 may perform a login verification with a user once again during establishment of a cloud service connection.

Optionally, when identity verification fails or the number of failure times of the identity verification reaches a predetermined number of times (e.g., three times, five times, etc.), the wireless communication device 53 may be locked to be incapable of further use, for example, it may be locked for a period of time before the identity verification is performed once again; and when the identity verification performed once again fails or the number of failure times reaches a predetermined number of times again, it may be locked for longer time before the following identity verification is performed. In addition, optionally, when the accumulated number of times of identity verification during a predetermined time period (e.g., within a day or a week) reaches a greater numerical value (e.g., 10 times or 20 times), it is deemed that there is a great possibility that the wireless communication device 53 has been lost or stolen, and the wireless communication device 53 may send its current location to a predetermined device (e.g., the cloud server end 54 or other network side devices, such as a network side device providing security), so that a user of the wireless communication device 53 can acquire the current location of the wireless communication device 53 so as to facilitate retrieval of the wireless communication device 53. Sending of the current location may be periodic, and may also be triggered based on an event, for example, at the time when the accumulated number of times of identity verification reaches a greater numerical value, or the wireless communication device 53 receives a device retrieval command issued by a user through other means (e.g., issuing the device retrieval command through the cloud server end 54), the wireless communication device 53 is triggered to send the current location. This can enhance security of a cloud service.

503, the cloud server end 54 may record information of the wireless communication device 53, indicating that the wireless communication device 53 is being used by the user, so that a cloud editing service provided by the cloud server end 54 can be used.

504, the editing terminal 51 of the user establishes a short-range wireless connection with the wireless communication device 53. For example, the editing terminal 51 may have a Bluetooth function module for establishing a Bluetooth connection with the wireless communication device 53. The present disclosure does not make a limitation to a protocol type and mode in which the editing terminal 51 establishes the short-range wireless connection with the wireless communication device 53.

As one non-limiting example, the editing terminal 51 may be a handwriting panel in the home of a user, and the user employs a computing device to use a cloud editing service provided by the cloud server end 54 through the wireless communication device 53, for example, drawing a certain picture. During editing, the editing terminal 51 may upload some of edited picture documents to the cloud server end 54 periodically or according to a document storage instruction of the user, and the operation may be referred to as a document synchronization operation.

505, the user needs to go out to an office, and therefore, inputs a document storage instruction on the editing terminal 41, and stores some of edited picture documents to the cloud server end 54.

506, the editing terminal 51 sends the document storage instruction of the user to the cloud server end 54 through the wireless communication device 53. Optionally, if updated content of some of picture documents still has not been synchronized to a cloud server end prior to a storage instruction of this document, this part of the updated content may be sent to the cloud server end together.

507, after the cloud server end 54 receives the document storage instruction and the updated content of the user, related picture documents are updated on the cloud server end 54.

508, when the user arrives at the office, the editing terminal 52 in the office establishes a short-range wireless connection with the wireless communication device 53. For example, the editing terminal 52 may have a Bluetooth function module for establishing a Bluetooth connection with the wireless communication device 53. The present disclosure does not make a limitation to a protocol type and mode in which the editing terminal 52 establishes the short-range wireless connection with the wireless communication device 53.

As one non-limiting example, the editing terminal 52 may be a notebook computer in an office, and a user employs the computer to use a cloud editing service provided by the cloud server end 54 through the wireless communication device 53, for example, drawing a certain picture.

509, the user downloads a picture document which has not been edited at step 505 to the editing terminal 52 through the wireless communication device 53.

The wireless communication device 53 may provide an instruction menu for a user to input a download instruction, or the wireless communication device 53 may send instruction menu information to the editing terminal 52 so that the editing terminal 52 displays the instruction menu according to the instruction menu information, thereby allowing the user to input the download instruction on the editing terminal 52. As another embodiment, the cloud server end 54 may push the picture document actively to the wireless communication device 53 and further to the editing terminal 52 currently connected with the wireless communication device 53.

510, the user uses the editing terminal 52 to continue to draw a picture. During editing, the editing terminal 52 may upload some of edited picture documents to the cloud server end 54 periodically or according to a document storage instruction of the user.

As such, according to the present embodiment, use of a cloud service by a user terminal device can be achieved through a wireless communication device, and the user terminal device only needs a short-range wireless connection capability to be easily connected with the wireless communication device.

Therefore, optionally, as one embodiment, in a wireless communication system of one embodiment of the present disclosure, after identity verification of a user of a wireless communication device is successful, a cloud server end may further record information of the wireless communication device to represent that the wireless communication device is being used by the user.

In this case, after the wireless communication device establishes a short-range wireless connection with one or more external terminal device(s), the wireless communication device may further send device information of the external terminal device to the cloud server end, and the cloud server end may record the device information of the external terminal device, for example, device identification, device capability information (such as capturing a picture) and/or other parameter information (such as a format, size of a picture, etc.).

Taking a case where external terminal devices include at least two terminal devices such as a first external terminal device and a second external terminal device as an example, a wireless communication device may receive, via a short-range wireless connection with the first external terminal device, data (such as picture data or character data, etc.) acquired by the first external terminal device, and send the data to a cloud server end via a cloud service connection.

The cloud server end may perform a format conversion processing on the data according to the device information of the second external terminal device to obtain converted data. The cloud server end may send the converted data to the wireless communication device via a cloud service connection. Then, the wireless communication device may send the converted data to the second external terminal device via the short-range wireless connection with the second external terminal device so that the converted data is displayed on the second external terminal device.

The above data format conversion processing may also be performed on a cloud hotspot. In this case, for example, the wireless communication device may receive the above data (without a format conversion processing) of which a destination is the second external terminal device from the cloud server end via the cloud service connection. The wireless communication device may perform a format conversion processing on the data according to the device information of the second external terminal device so as to obtain converted data, and send the converted data to the second external terminal device via the short-range wireless connection with the second external terminal device so that the converted data is displayed on the second external terminal device.

Optionally, as another embodiment, the wireless communication device may receive, via a short-range wireless connection with the first external terminal device, first processing instruction information (such as pausing the play, saving a document, modifying a character, etc.) on a current cloud service data stream sent by the first external terminal device, and send the first processing instruction information to the cloud server end via the cloud service connection. The cloud server end processes the current cloud service data stream according to the first processing instruction information.

In this case, optionally, the cloud server end may further record status information of the cloud service data stream processed according to the first processing instruction information (such as breakpoint time information about playing, modified document content, etc.). The wireless communication device may receive, via the short-range wireless connection with the second external terminal device, second processing instruction information (such as a resume playing instruction, a new character modification instruction, etc.) on the current cloud service data stream sent by the second external terminal device, and send the second processing instruction information to the cloud server end via the cloud service connection. Then, the cloud server end may process the current cloud service data stream according to the second processing instruction information and the status information.

As such, a cloud hotspot of the present disclosure can provide a user with service experience following the user, and provide a uniform cloud service whatever terminal the user uses without being overly limited to hardware or software of the terminal, that is, the cloud hotspot can not only provide a highly qualified cloud service, but also make full use of an existing terminal device of the user without requiring the user to purchase a specially customized terminal, thereby saving social resources significantly, and promoting environment protection and resource reuse. A terminal device having a short-range wireless connection capability (the cost of such a terminal is very low, and easy for promotion) may even be provided in a public place or a private occasion (such as a bus station, a bank, a roadside, a building lobby, a vehicle, etc.). As long as a user carries a cloud hotspot customized with a cloud service, his or her own cloud service can be used on such a terminal device without worrying information security problem, and thus such a cloud service can bring a user great convenience.

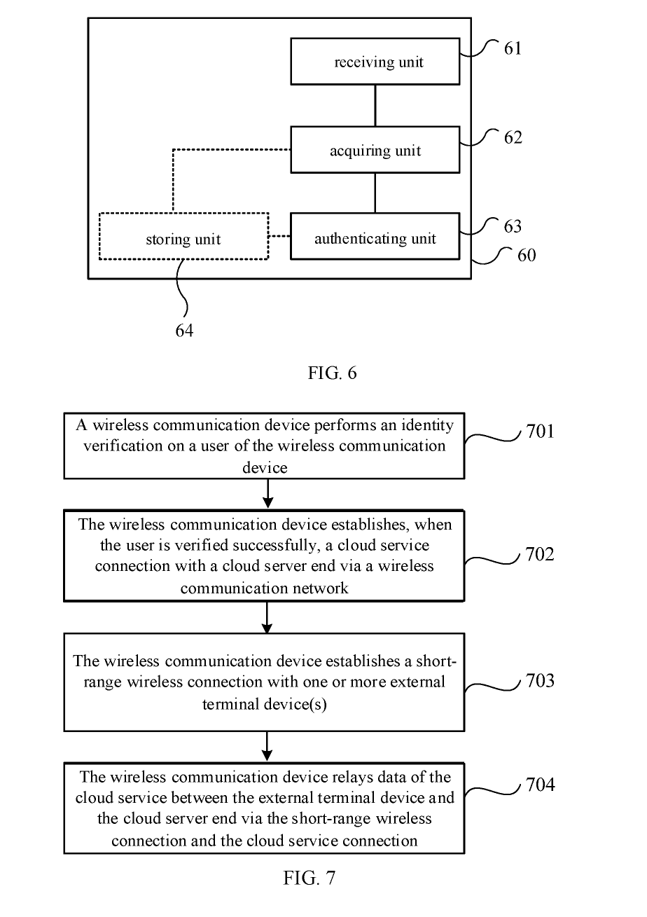

FIG. 6 is a schematic block diagram of a cloud server end of an embodiment of the present disclosure.

A cloud server end 60 of FIG. 6 is located at a network side and serves as a subscriber identity authentication proxy of a terminal, and the terminal is not configured with a subscriber identity module (such as a SIM card) and cannot be connected with a subscriber identity module (such as having no SIM card slot). The cloud server end 60 includes a receiving unit 61, an acquiring unit 62 and an authenticating unit 63.

The receiving unit 61 is configured to receive a device identifier of a terminal.

The acquiring unit 62 is configured to acquire a subscriber identity of the terminal according to the device identifier of the terminal.

The authenticating unit 63 is configured to perform an authentication processing with an authentication server of a mobile communication network based on the user identifier.

As such, a cloud server end can serve as a subscriber identity authentication proxy of a terminal. Although the terminal is not configured with the subscriber identity module and cannot be connected with the subscriber identity module, the subscriber identity authentication proxy of the terminal can also be achieved.

This can exempt use of a subscriber identity card such as a SIM card, save space of a terminal, and enable volume of the terminal to be more compact. In the other aspect, since messaging for an access verification processing between the terminal and the wireless communication network is not required, electric power of the terminal can also be saved. This is an actual NO SIM CARD solution. Currently, there exists solutions such as a virtual SIM card or an e-SIM card, however, these solutions do not exempt a SIM card completely, but merely convert the SIM card into a built-in or embedded chip.

The terminal herein is generally a mobile terminal, but the present disclosure does not make a limitation to a specific implementation form of the terminal, and a terminal in which a plug-in SIM card or an embedded SIM card present in the art may be applied can be improved as a terminal of the present disclosure.

As shown in FIG. 6, the cloud server end 60 further includes a storing unit 64 configured to store at least one set of correspondences between device identifiers and subscriber identifiers of terminals. The acquiring unit 62 looks up the correspondences according to a device identifier of a terminal so as to acquire a user identifier of the terminal.

In this case, the cloud server end may send a device identifier and a corresponding user identifier of the wireless communication device 20 to a server of an operator end, and the operator end performs an authentication and activation operation on the basis of the user identifier (e.g., exchanging authentication information with the cloud server end, and optionally, allocating a TMSI for the user identifier, and other operations), so that the wireless communication device may communicate with a wide area network using a wireless communication network.

Optionally, as another embodiment, the storing unit 64 may further store authentication information required for an authentication processing. The authenticating unit 63 may perform the authentication processing based on the authentication information and the above user identifier.

Optionally, as another embodiment, the acquiring unit 62 may send a device identifier of a terminal to an authentication server, and receive a user identifier of the terminal from the authentication server, where the authentication server stores at least one set of correspondences between device identifiers and subscriber identifiers of terminals.

Optionally, as another embodiment, the acquiring unit 62 may take a device identifier received from the receiving unit 61 as a user identifier of a terminal.

FIG. 7 is a flowchart of a communication method of a wireless communication system of an embodiment of the present disclosure. A wireless communication system in which a method of FIG. 7 may be applied includes a wireless communication device and a cloud server end mutually connected via a wireless communication network, where the cloud server end provides a cloud service for a user of the wireless communication device. An example is a wireless communication system shown in FIG. 1. Each process of the method of FIG. 7 may refer to the corresponding process or function in the previous embodiments of FIG. 1 to FIG. 6, and will not be described in details to avoid repetition.

701, a wireless communication device performs an identity verification on a user of the wireless communication device.

For example, the identity verification may be performed with reference to description of the above steps 301, 401 and 501.

702, the wireless communication device establishes a cloud service connection with a cloud server end via a wireless communication network when the user is verified successfully.

For example, a cloud service connection may be established with reference to description of the above steps 302, 402 and 502.

703, the wireless communication device establishes a short-range wireless connection with one or more external terminal device(s).

For example, a short-range wireless connection may be established with reference to description of the above steps 304, 404/408 and 504/508. It shall be noted that step 703 may be executed ahead of step 701 or 702, or simultaneously with step 701 or 702 depending on different specific application scenarios.

704, the wireless communication device relays data of the cloud service between the external terminal device and the cloud server end via the short-range wireless connection and the cloud service connection.

For example, cloud service data may be relayed with reference to description of the above steps 309/311, 406/409-412 and 506/509.

As such, in the embodiment of the present disclosure, one wireless communication device provides a uniform access and verification processing of a cloud service for one user, so that lower design requirement is required from various terminal devices of the user, and design and production costs of the terminal devices can be reduced.

Furthermore, the uniform access and verification processing of a cloud service for one user provided by one wireless communication device, interconnection between each of terminal devices of the user can be realized better, for example, a picture captured by a digital camera of the user may perform instant presentation on a cell phone of the user conveniently, thereby enhancing user experience significantly.

Optionally, as another embodiment, the wireless communication device or the cloud server end may further perform an access verification with a wireless communication network.

Optionally, as another embodiment, the cloud server end may acquire an identity identifier corresponding to a device identifier of the wireless communication device, and then perform an authentication processing with an operator end based on the identity identifier.

Optionally, as another embodiment, the cloud server end may store at least one set of correspondences between device identifiers and identity identifiers of wireless communication devices so as to acquire the identity identifier corresponding to the device identifier of the wireless communication device. Alternatively, a cloud server may receive an identity identifier corresponding to a device identifier of the wireless communication device from the operator end, where the operator end stores at least one set of correspondences between device identifiers and identity identifiers of wireless communication devices.

Optionally, as another embodiment, the device identifier and the identity identifier are the same identifier.

Optionally, as another embodiment, the wireless communication device may further perform a login verification with the cloud server end.

Optionally, as another embodiment, the wireless communication network may include a mobile communication network and/or a wireless local area network.

Optionally, as another embodiment, the wireless communication device is a portable device.

Optionally, as another embodiment, the identity verification may include at least one of a biological information verification, an input verification and a hardware device verification.

Optionally, as another embodiment, the short-range wireless connection may include at least one of a WiFi connection, a Bluetooth connection, an infrared connection and a visible light connection.

Optionally, as another embodiment, the wireless communication device may lock the wireless communication device to be incapable of further use, and/or send a location of the wireless communication device to the cloud server end or other network side devices, when the number of failure times of the identity verification reaches a predetermined number of times.

As an extension terminal of a cloud service for a user, a cloud hotspot of the present disclosure can provide the user with the cloud service along with him or her, enhancing user experience significantly, while reducing a requirement for a network connection capability of a related electronic product, and thus the cloud hotspot is more suitable for popularization and application. In addition, the cloud hotspot of the present disclosure can guarantee security of a cloud service of a user, even though the cloud hotspot is lost or stolen, it can still prevent others from obtaining cloud service information of the user and using the cloud service of the user. Furthermore, the cloud hotspot of the present disclosure can support an actual NO SIM CARD solution so that the volume of the cloud hotspot is more compact, power consumption is less, and application is more flexible.

Those of ordinary skill in the art may be aware that, units and algorithm steps of the examples described in the embodiments disclosed in this text may be implemented by electronic hardware, or a combination of computer software and electronic hardware. Whether these functions are executed in hardware or software mode depends on the specific applications and design constraint conditions of the technical solution. Those skilled may implement the described functions by using different methods for each specific application, but this implementation should not be considered to be beyond the scope of the present disclosure.

Those skilled in the art to which the present disclosure pertains may clearly understand that, for convenience and simplicity of description, for the specific working processes of the system, the apparatus and the units described above, please refer to corresponding processes in the foregoing method embodiments, and they will not be repeated redundantly herein.

In the several embodiments provided in the present application, it should be understood that, the disclosed system, device and method may be implemented in other manners. For example, the apparatus embodiments described above are merely exemplary, e.g., the division of the units is merely a logic function division, other division manners may exist in practical implementation, for example, a plurality of units or components may be combined or integrated to another system, or some features may be omitted or not implemented. From another point of view, the displayed or discussed mutual coupling or direct coupling or communication connection may be indirect coupling or communication connection via some interfaces, apparatuses or units, and may be in electrical, mechanical or other forms.

The units described as separate parts may be or may not be separated physically, and a component displayed as a unit may be or may not be a physical unit, namely, may be located in one place, or may be distributed on a plurality of network units. A part of or all of the units may be selected to achieve the purposes of the solutions in the present embodiments according to actual demands.

In addition, the respective functional units in the respective embodiments of the present disclosure may be integrated in one processing unit, or the respective units singly exist physically, or two or more units are integrated in one unit.

When the function is implemented in the form of the software functional unit and is sold or used as an independent product, it may be stored in a computer readable storage medium. Based on such understanding, the technical solution of the present disclosure substantially, or the part of the present disclosure making contribution to the prior art, or a part of the technical solution may be embodied in the form of a software product, and the computer software product is stored in a storage medium, which includes multiple instructions enabling computer equipment (which may be a personal computer, a server, network equipment or the like) to execute all of or part of the steps in the methods of the embodiments of the present disclosure. The foregoing storage medium includes a variety of media capable of storing program codes, such as a USB disk, a mobile hard disk, a read-only memory (ROM), a random access memory (RAM), a magnetic disk, an optical disk or the like.

Described above are the specific embodiments of the present disclosure only, but the protection scope of the present disclosure is not limited to this, those skilled who are familiar with the art could readily think of variations or substitutions within the technical scope disclosed by the present disclosure, and these variations or substitutions shall fall within the protection scope of the present disclosure. Therefore, the protection scope of the present disclosure should be determined with reference to the protection scope of the claims.

What is claimed is:

1. A wireless communication device, comprising:
a verifying module, configured to perform an identity verification on a user of the wireless communication device;
a first accessing module, configured to establish, when the verifying module verifies the user successfully, a cloud service connection with a cloud server end of the user via a wireless communication network;
a second accessing module, configured to establish a short-range wireless connection with one or more external terminal device(s); and
a transmitting module, configured to relay data between the external terminal device and the cloud server end via the short-range wireless connection and the cloud service connection.

2. The wireless communication device according to claim 1, wherein the verifying module is further configured to perform an access verification with the wireless communication network or a login verification with the cloud server end.

3. The wireless communication device according to claim 1, wherein the wireless communication network comprises at least one of a mobile communication network or a wireless local area network.

4. The wireless communication device according to claim 1, wherein the wireless communication device is a portable device.

5. The wireless communication device according to claim 1, wherein the identity verification comprises at least one of a biological information verification, an input verification and a hardware device verification.

6. The wireless communication device according to claim 1, wherein the short-range wireless connection comprises at least one of a WiFi connection, a Bluetooth connection, an infrared connection and a visible light connection.

7. The wireless communication device according to claim 1, wherein the verifying module is further configured to lock the wireless communication device to be incapable of further use, when the number of failure times of the identity verification reaches a predetermined number of times.

8. The wireless communication device according to claim 1, wherein the verifying module is further configured to send a location of the wireless communication device to the cloud server end or other network side devices through the transmitting module, when the number of failure times of the identity verification reaches a predetermined number of times.

9. A wireless communication system, comprising a wireless communication device and a cloud server end mutually connected via a wireless communication network, wherein:
the cloud server end is configured to provide a cloud service to a user of the wireless communication device;
the wireless communication device is configured to perform an identity verification on the user of the wireless communication device, and establish a cloud service connection with the cloud server end via the wireless communication network when the user is successfully verified;
the wireless communication device is further configured to establish a short-range wireless connection with one or more external terminal devices; and
the wireless communication device is further configured to relay data of the cloud service between the external terminal device and the cloud server end via the short-range wireless connection and the cloud service connection.

10. The wireless communication system according to claim 9, wherein the wireless communication device or the cloud server end is further configured to perform an access verification with the wireless communication network.

11. The wireless communication system according to claim 10, wherein,
the cloud server end is configured to acquire an identity identifier corresponding to a device identifier of the wireless communication device; and
the cloud server end is configured to perform an authentication processing with an operator end based on the identity identifier.

12. The wireless communication system according to claim 11, wherein,
the cloud server end is configured to store at least one set of correspondences between device identifiers and identity identifiers of wireless communication devices so as to acquire the identity identifier corresponding to the device identifier of the wireless communication device; or
the cloud server end is configured to receive the identity identifier corresponding to the device identifier of the wireless communication device from the operator end, wherein the operator end stores at least one set of correspondences between device identifiers and identity identifiers of the wireless communication devices.

13. The wireless communication system according to claim 10, wherein, the device identifier and the identity identifier are the same identifier.

14. The wireless communication system according to claim 9, wherein, after the identity verification of the user of the wireless communication device is successful, the cloud server end is further configured to record information of the wireless communication device so as to indicate that the wireless communication device is being used by the user.

15. The wireless communication system according to claim 9, wherein, after the wireless communication device establishes the short-range wireless connection with the one or more external terminal device(s), the wireless communication device is further configured to send device information of the external terminal device to the cloud server end, and the cloud server end is further configured to record the device information of the external terminal device.

16. The wireless communication system according to claim 15, wherein the one or more external terminal devices comprise at least a first external terminal device and a second external terminal device, and
the wireless communication device is configured to receive data acquired by the first external terminal device via the short-range wireless connection with the first external terminal device, and send the data to the cloud server end via the cloud service connection;
the cloud server end is configured to perform a format conversion processing on the data according to the device information of the second external terminal device so as to obtain converted data;
the cloud server end is further configured to send the converted data to the wireless communication device via the cloud service connection; and
the wireless communication device is further configured to send the converted data to the second external terminal device via the short-range wireless connection with the second external terminal device so that the converted data is used on the second external terminal device.

17. The wireless communication system according to claim 15, wherein the one or more external terminal devices comprise at least a first external terminal device and a second external terminal device, and
the wireless communication device is configured to receive data acquired by the first external terminal device via the short-range wireless connection with the first external terminal device, and send the data to the cloud server end via the cloud service connection;
the wireless communication device is further configured to receive the data of which a destination is the second external terminal device from the cloud server end via the cloud service connection; and
the wireless communication device is further configured to perform a format conversion processing on the data according to the device information of the second external terminal device so as to obtain converted data, and send the converted data to the second external terminal device via the short-range wireless connection with the second external terminal device so that the converted data is used on the second external terminal device.

18. The wireless communication system according to claim 9, wherein the one or more external terminal devices comprise at least a first external terminal device and a second external terminal device, and
the wireless communication device is configured to receive, via a short-range wireless connection with the first external terminal device, first processing instruction information on a current cloud service data stream sent by the first external terminal device, and send the first processing instruction information to the cloud server end via the cloud service connection; and
the cloud server end is configured to process the current cloud service data stream according to the first processing instruction information.

19. The wireless communication system according to claim 18, wherein the cloud server end is further configured to record status information of the cloud service data stream processed according to the first processing instruction information;
the wireless communication device is further configured to receive, via the short-range wireless connection with the second external terminal device, second processing instruction information on the current cloud service data stream sent by the second external terminal device, and send the second processing instruction information to the cloud server end via the cloud service connection; and
the cloud server end is configured to process the current cloud service data stream according to the second processing instruction information and the status information.

20. A communication method of a wireless communication system, the wireless communication system comprising a wireless communication device and a cloud server end mutually connected via a wireless communication network, and the cloud server end providing a cloud service to a user of the wireless communication device, the method comprising:
performing, by the wireless communication device, an identity verification on the user of the wireless communication device;
establishing, by the wireless communication device, a cloud service connection with the cloud server end via the wireless communication network when the user is successfully verified;
establishing, by the wireless communication device, a short-range wireless connection with one or more external terminal devices; and
relaying, by the wireless communication device, data of the cloud service between the external terminal device and the cloud server end via the short-range wireless connection and the cloud service connection.
